(19) United States
(12) Patent Application Publication
(10) Pub. No.: US 2026/0064895 A1
(43) Pub. Date: Mar. 5, 2026

(54) INFORMATION HANDLING SYSTEM INTRUSION DETECTION AND POWER MANAGEMENT

(71) Applicant: Dell Products L.P., Round Rock, TX (US)

(72) Inventors: Allen B. McKittrick, Cedar Park, TX (US); Jeffrey D. Kane, Austin, TX (US); Daniel L. Hamlin, Round Rock, TX (US)

(73) Assignee: Dell Products L.P., Round Rock, TX (US)

(21) Appl. No.: 18/824,520

(22) Filed: Sep. 4, 2024

(51) Int. Cl. G06F 21/86

(52) U.S. Cl. CPC G06F 21/86

(57) ABSTRACT

An information handling system intrusion detection sensor detects opening of a housing and in response automatically cuts off power communicated from a battery to the processing components of the system. At detection of an opening of the housing, intrusion detection information is generated and stored in non-transitory memory before the power of the battery is cut off. Power cut off may be delayed to communicate the intrusion detection information or the intrusion detection information may be communicated with a security radio having a secondary battery.

### BACKGROUND OF THE INVENTION

### Field of the Invention

The present invention relates in general to the field of portable information handling systems, and more particularly to an information handling system intrusion detection and power management.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a battery power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In a clamshell configuration, the lid housing portion rotates approximately ninety degrees to a raised position above the main housing portion so that an end user can type inputs while viewing the display. After usage, convertible information handling systems rotate the lid housing portion over the main housing portion to protect the keyboard and display, thus reducing the system footprint for improved storage and mobility.

One difficulty with portable information handling systems is that integrated batteries store a good amount of power that can cause damage to the system if inadvertently released. For example, even though an information handling system is powered down, some components retain residual power and can have a soft power down state that supports a rapid system start. If the information handling system housing is accessed in the powered off state, unintentional touches within the housing can cause an electrical shock to an end user if the wrong components are touched. To protect against electrical shock, the end user has to unplug the information handling system and also disconnect the battery from the system power bus to remove all power from the system. In addition to the risk of electrical shock, the presence of residual power in components presents a risk of damage from electrostatic discharge (ESD). Disconnecting a battery and removing power from an information handling system helps to reduce risk of damage by ESD. To help technicians safely repair portable information handling systems, a battery disconnect switch is sometimes placed next to the battery connector to disconnect power from the motherboard without removing the connector. The battery disconnect switch helps prevent static discharge damage through battery connector insertion cycling, however, it adds cost and consumes footprint so that in some systems it is not practical to include.

Another difficulty with portable information handling systems is physical security. During a theft, one common action is to open the housing and remove wireless antenna that transmit security tracking. Once the housing is open and the system cannot be tracked, the thief can take his time to access information stored in the system. Even when a physical access within a housing is legitimate, opening the housing can introduce contamination and result in system changes that invalidate the system warranty. To track intrusions, an intrusion detection switch is sometimes coupled with the housing and interfaced with an embedded controller to store information associated with the intrusion.

### SUMMARY OF THE INVENTION

Therefore, a need has arisen for a system and method which detects and reports information handling system intrusions while disconnecting a battery in response to the intrusion.

In accordance with the present invention, a system and method are provided which substantially reduce the disadvantages and problems associated with previous methods and systems of managing power in an open information handling system housing. An intrusion detection sensor detects when the housing is opened and in response battery power to the motherboard is cut off. In an example embodiment, power cut off is delayed to permit storage and communication of intrusion detection information.

More specifically, a portable information handling system encloses a motherboard and processing components in a housing with a battery. An intrusion detection sensor detects when the housing is opened and sends a signal to a processing resource that cuts off power by the battery to the motherboard. For example, a GPIO signal to an embedded controller commands a disconnect of the battery power communication to the motherboard. When the housing is detected as open, the embedded controller gathers intrusion detection information, stores the information in a non-transitory memory and communicates the information to a network location. In various embodiments, the intrusion detection sensor can communicate the housing open signal to the battery for the battery BMU to turn off power or to a physical hard-off switch that disconnects the battery.

The present invention provides a number of important technical advantages. One example of an important technical advantage is that a technician who is opening the housing does not have to manually turn off the battery or disconnect the battery. This reduces the risk of an inadvertent shock or ESD damage. Automated detection of the housing closed reduces the risk that a technician will forget to switch on the battery when reassembling the system. The additional protection is provided with minimal cost or footprint.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a top view of an example embodiment of a portable information handling system having an intrusion detection sensor that cuts off power from a battery when an intrusion into the housing is detected;

FIG. 2 depicts a top detail view of an example embodiment of an intrusion detection switch for detecting an opening of the housing;

FIG. 3 depicts a side sectional view of a housing cover coupled over the housing to engage the intrusion detection switch; and

FIG. 4 depicts a flow diagram of a process for managing power at an information handling system when the housing opens.

### DETAILED DESCRIPTION

A portable information handling system intrusion detection sensor cuts off power from a battery when a housing intrusion is detected. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

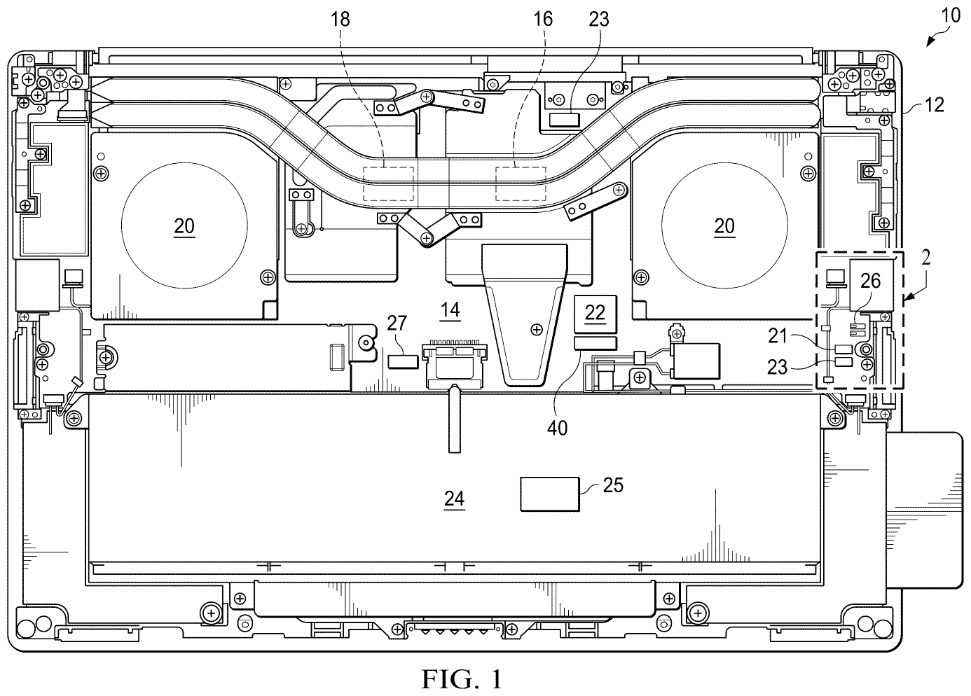

Referring now to FIG. 1, a top view depicts an example embodiment of a portable information handling system 10 having an intrusion detection sensor that cuts off power from a battery 24 when an intrusion into housing 12 is detected. Information handling system 10 processes information with processing components coupled in a housing 12 and to a motherboard 14. A central processing unit (CPU) 16 executes instructions to process information in cooperation with a random access memory (RAM) 18 that stores the instructions and information. Cooling fans 20 remove excess thermal energy generated by power dissipation through the processing components. An embedded controller 22 manages operating conditions in housing 12, such as the application of power and maintenance of thermal conditions. Embedded controller 22 executes embedded code stored in a flash memory 40 or similar non-transient memory. Power is supplied to the processing components from a battery 24 that connects to motherboard 14. A wireless local area network radio 23 supports communication with external devices, such as through WIFI or BLUETOOTH.

When housing 12 is opened to exposed motherboard 14, an intrusion detection sensor 26 detects the open housing and communicates the open condition to embedded controller 22. In the example embodiment, intrusion detection sensor 26 is a spring biased switch that closes to generate a high signal when the housing cover portion is removed from the housing main portion. In alternative embodiments, the intrusion detection sensor may be an ambient light sensor (ALS) 21 that detects ambient light when the opening of the housing allows ambient light into the housing or a Hall sensor 23 that detects separation of a magnet in the housing cover from the Hall sensor in the housing main portion. Embedded controller 22 responds to the open housing signal by cutting off power from battery 24 to motherboard 14. In one embodiment, embedded controller 22 detects a GPIO output from the intrusion detection sensor and commands a battery management unit 25 processing resource of battery 24 to shut down power. In an alternative embodiment, embedded controller 22 commands a hard-off switch 27 to cut off battery power communication at the connection with the motherboard. In another embodiment, embedded controller 22 gathers intrusion detection information, such as intrusion time and location, stores the intrusion detection information in non-transitory memory, and commands a radio to transmit the intrusion detection information to a network location, such as WLAN 23. In an alternative embodiment, an intrusion detection event communicated by the intrusion detection sensor to BMU 25 or hard-off switch 27 causes the power cut off. In either arrangement, a time delay may be included so that the radio has time to communicate the intrusion detection information before power is cut off. When the radio has its own power, such as a secondary battery, the power cut off from battery 24 may be instantaneous with the radio transmitting the intrusion detection information with the secondary battery source.

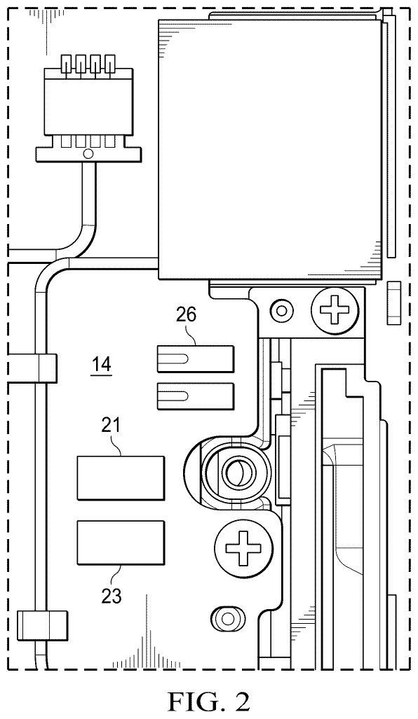

Referring now to FIG. 2, a top detail view depicts an example embodiment of an intrusion detection switch for detecting an opening of the housing. The intrusion detection switch 26 has first and second spring loaded arms that press against a housing cover when the housing cover couples over motherboard 14. As the housing cover lifts away from the main housing and motherboard, the switch closes to communicate a high signal as a GPIO input through the motherboard to the embedded controller. In one example embodiment, the GPIO signal wakes the embedded controller and executes a command cut off power from the battery, as described above. When the battery is connected or reconnected and the GPIO signal is high, instructions in the embedded controller intercede to prevent the battery power cut off.

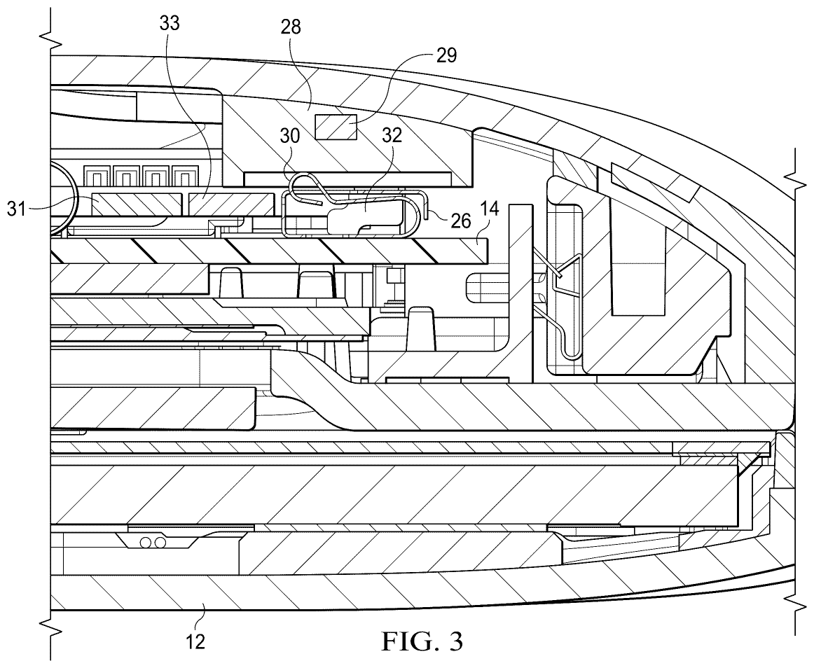

Referring now to FIG. 3, a side sectional view depicts a housing cover 28 coupled over the housing 12 to engage the intrusion detection sensor 26. A spring biased arm 30 extends up against housing cover 28 and opens a switch 32 when housing cover 28 couples in place. When housing cover 28 is removed, spring biased arm 30 closes switch 32 to send the high signal to the embedded controller through motherboard 14. In the example embodiment, a magnet 29 is included in the housing cover to provide a magnetic field to a Hall sensor when the housing cover is in place and trigger the GPIO when the housing cover is removed. In the example embodiment, a theft beacon 33 with a secondary battery 31 also receives the GPIO signal to send out the intrusion detection information after power is cut off from the battery.

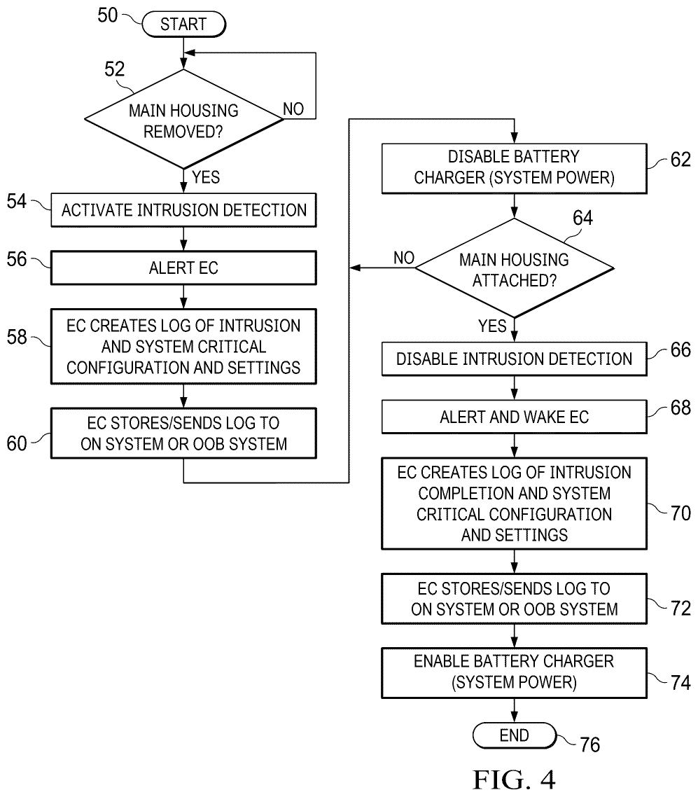

Referring now to FIG. 4, a flow diagram depicts a process for managing power at an information handling system when the housing opens. The process starts at step 50 and at step 52 determines if the housing main cover is removed. If not, the process repeats until an open housing is detected. At step 54, the open housing activates intrusion detection, such as with a switch, and ALS or a Hall sensor. At step 56, the intrusion detection sensor alerts the embedded controller of the intrusion. At step 58, the embedded controller creates a log of the intrusion information to include the system critical configuration and settings. At step 60, the embedded controller stores the intrusion information in non-transitory memory and sends the intrusion information to a network location through an out of band communication link. At step 62, the battery is disabled through a command to the battery charger that turns off battery power to the motherboard.

At step 64, the process iteratively detects if the main housing has the cover removed and returns to step 62 until the intrusion detection sensor detects the housing is closed. At step 66, the intrusion detection signal is disabled and at step 68 an alert and wake command issues to the embedded controller, such as in response to the GPIO signal indicating that the housing is closed. At step 70 the embedded controller creates a log that the detected intrusion is complete by saving the system critical configuration and settings. At step 72 the embedded controller sends the log to the non-transitory memory and to a network location as described above. At step 74 the battery power communication is enabled at the battery charger and the process ends at step 76.

Although the present invention has been described in detail, it should be understood that various changes, substitutions and alterations can be made hereto without departing from the spirit and scope of the invention as defined by the appended claims.

What is claimed is:

1. An information handling system comprising:
a portable housing;
a motherboard coupled in the portable housing;
a processor coupled to the motherboard and operable to execute instruction that process information;
a memory coupled to the motherboard and interfaced with the processor, the memory operable to store the instructions and information;
an embedded controller coupled to the motherboard and operable to manage power applied to the motherboard;
a battery coupled in the housing and interfaced with the motherboard to power the motherboard;
an intrusion detection sensor interfaced with the housing and the embedded controller and operable to detect opening of the housing that exposes the motherboard; and
a non-transitory memory interfaced with the embedded controller and storing instructions that when executed on the embedded controller cause:
detection by the intrusion detection sensor of opening of the housing; and
in response to the detection, cutting off power communication from the battery to the motherboard.

2. The information handling system of claim 1 further comprising instructions stored in the non-transitory memory that when executed on the embedded controller cause:
in response to the detection, gathering intrusion event information; and
storing the intrusion event information is the non-transitory memory before the cutting off power communication.

3. The information handling system of claim 2 further comprising:
a radio; and
instructions stored in the non-transitory memory operable to communicate the intrusion event information before the cutting off power communication.

4. The information handling system of claim 2 wherein the intrusion detection sensor comprises a contact switch placed to trigger when the housing opens.

5. The information handling system of claim 2 wherein the intrusion detection sensor comprises an ambient light sensor triggered when light enters the housing.

6. The information handling system of claim 2 wherein the intrusion detection sensor comprises a Hall sensor trigged by a separation from magnet coupled to the housing.

7. The information handling system of claim 2 wherein the embedded controller cuts off power communication from the battery by a command sent to a battery management unit of the battery.

8. The information handling system of claim 2 further comprising:
a hard-off switch on the motherboard that selectively disconnects and reconnects the battery to the motherboard; and
the cutting off power communication turns off the hard-off switch.

9. The information handling system of claim 8 further comprising:
a radio;
a secondary battery interfaced with the radio; and
instructions that cause the radio to communicate the intrusion event information powered by the secondary radio.

10. A method for managing power at a housing of an information handling system, the method comprising:
detecting opening of the housing; and
in response to the detecting, cutting off power communication from a battery in the housing to a motherboard that supports processing components.

11. The method of claim 10 further comprising:
in response to the detecting, gathering intrusion event information; and
storing the intrusion event information in non-transitory memory of the motherboard before the cutting off power communication.

12. The method of claim 11 further comprising:
commanding the cutting off of power with a GPIO signal from an intrusion detection sensor to the battery; and
cutting off power in response to the GPIO signal with a battery management unit included in the battery.

13. The method of claim 12 wherein the intrusion detection sensor comprises an ambient light sensor.

14. The method of claim 12 wherein the intrusion detection sensor comprises a Hall sensor located proximate a magnet coupled in the housing.

15. The method of claim 11 further comprising:
delaying the cutting off of power for a predetermined time; and
communicating the intrusion event information from a radio in the predetermined time.

16. A system to manage power at a housing of an information handling system, the system comprising:
an embedded controller operable to manage power at the information handling system;
a battery interfaced with the embedded controller;
an intrusion detection sensor interfaced with the housing and the embedded controller and operable to detect opening of the housing; and
a non-transitory memory interfaced with the embedded controller and storing instructions that when executed on the embedded controller cause:
detection by the intrusion detection sensor of opening of the housing; and
in response to the detection, cutting off power communication from the battery to the motherboard.

17. The system of claim 16 further comprising:
instructions stored in the non-transitory memory that when executed on the embedded controller cause:
in response to the detection, gathering intrusion event information; and
storing the intrusion event information is the non-transitory memory before the cutting off power communication.

18. The system of claim 17 further comprising:
a radio; and
instructions stored in the non-transitory memory operable to communicate the intrusion event information before the cutting off power communication.

19. The system of claim 17 further comprising:
a hard-off switch that selectively disconnects and reconnects the battery; and
the cutting off power communication turns off the hard-off switch.

20. The system of claim 17 wherein the embedded controller cuts off power communication from the battery by a command sent to a battery management unit of the battery.
